(19) United States
(12) Patent Application Publication
(10) Pub. No.: US 2024/0308450 A1
(43) Pub. Date: Sep. 19, 2024

(54) JUNCTION BOX ASSEMBLY HAVING A RIB FOR REINFORCING AN OUTER WALL

(71) Applicant: Sumitomo Wiring Systems, Ltd., Yokkaichi-shi (JP)

(72) Inventors: Cody Hicks, Farmington Hills, MI (US); Brian Carnick, Farmington Hills, MI (US)

(21) Appl. No.: 18/185,859

(22) Filed: Mar. 17, 2023

(51) Int. Cl. B60R 16/023; H02G 3/08

(52) U.S. Cl. CPC B60R 16/0239; H02G 3/081

(57) ABSTRACT

A junction box assembly includes an upper case and a lower case. The upper case includes an outer wall and an inner wall disposed within and spaced apart from an inner surface of the outer wall so as to define a first space and a second space. The upper case further includes a rib disposed between the outer wall and the inner wall. The rib preventing the outer wall from warping. In one aspect, the lower case includes a bottom wall and the rib is spaced apart from the bottom wall to define a slot, and an opening is disposed in the bottom wall and is in fluid communication with the slot so as to allow for water to drain to a terminal support portion of the lower case.

### TECHNICAL FIELD

This disclosure relates to a junction box assembly having an outer wall and a rib configured to support the outer wall.

### BACKGROUND

A junction box assembly 500 includes an upper case 502 and a lower case 504. The upper case 502 includes an outer wall 506 that bounds an inner wall 508. The outer wall 506 defines a periphery of the upper case 502 and includes a front portion 506a, a back portion 506b and a pair of side portions 506c, 506d interconnecting the front portion 506a to the back portion 506b.

The lower case 504 includes a terminal support portion 510 which is configured to support terminals (not shown). The terminal support portion 510 is seated beneath the front portion 506a of the upper case 502 and extends beyond the upper case 502. The terminals are attached to electric components within the upper case 502 and the lower case 504 on one end and a wire harness on the other end opposite of the upper case 502. The terminals may place a cantilevered load onto the outer wall 506 and in particular the front portion 506a of the outer wall 506, which may cause the outer wall 506 to warp.

In addition, water may enter the space between the inner wall 508 and the outer wall 506. In such an event, the electric components stored in the junction box may be damaged.

Accordingly, it remains desirable to have junction box assembly configured to prevent the outer wall from warping due to a cantilevered force applied by the terminals. It is also desirable to include water drainage features to allow water disposed within the space between the outer wall and inner wall to drain.

### SUMMARY

In one aspect, an upper case is provided. The upper case includes an outer wall and an inner wall. The inner wall is disposed within and spaced apart from an inner surface of the outer wall so as to define a first space and a second space. The upper case further includes at least one rib. The rib is disposed between the outer wall and the inner wall so as to reinforce the outer wall.

In one aspect, the outer wall and the inner wall bound a rectangle dimension. In such an aspect, the upper case includes a bottom wall and the at least one rib is spaced apart from the bottom wall to define a slot. The bottom wall may include an opening, the opening contiguous with the slot. In such an aspect, the bottom wall extends between the inner wall and the outer wall.

In one aspect, the upper case includes five ribs. In such an aspect, the upper case includes five openings and five slots. In such an aspect, the outer wall may include at least one recess portion, the at least one rib interconnecting the inner wall to the at least one recess portion. For instance, the outer wall may include five recess portions, five openings and five slots. In such an aspect, the opening, the slot and the at least one rib are disposed along a common plane.

A junction box assembly for housing electric components is also provided herein. The junction box assembly includes a lower case having a terminal support portion and an upper case mounted onto the lower case. The upper case may include an outer wall and an inner wall disposed within the outer wall. The terminal support portion may extend beyond an outer surface of the outer wall of the upper case. The upper case may further include a rib. The rib may be disposed between the outer wall and the inner wall.

In one aspect, the outer wall and the inner wall bound a rectangle dimension.

In another aspect, the upper case may include a bottom wall. The bottom wall may be spaced apart from and above the terminal support portion of the lower case. The rib may be spaced apart from the bottom wall to define a slot. In such an aspect, the bottom wall may include an opening. The opening may be contiguous with the slot. The opening is configured to allow water to drain from the upper case onto the terminal support portion of the lower case. In such an aspect, the bottom wall extends between the inner wall and the outer wall.

In yet another aspect, the outer wall of the upper case includes five ribs. In such an aspect, the upper case may include five openings and five slots.

In yet another aspect, the outer wall may include a recess portion, wherein the rib interconnects the inner wall to the recess portion. In such an aspect, the outer wall may include five recess portions. In yet another aspect, the opening, the slot and the rib are disposed along a common plane.

Accordingly, an upper case and a junction box is provided, which includes a rib configured to provide structural support to the outer wall so as to help prevent the outer wall from deforming due to a cantilevered load. In yet another benefit, the upper case includes a slot and an opening to allow for water to drain.

### DESCRIPTION OF DRAWINGS

FIG. 1 is a top down view of a conventional junction box assembly.

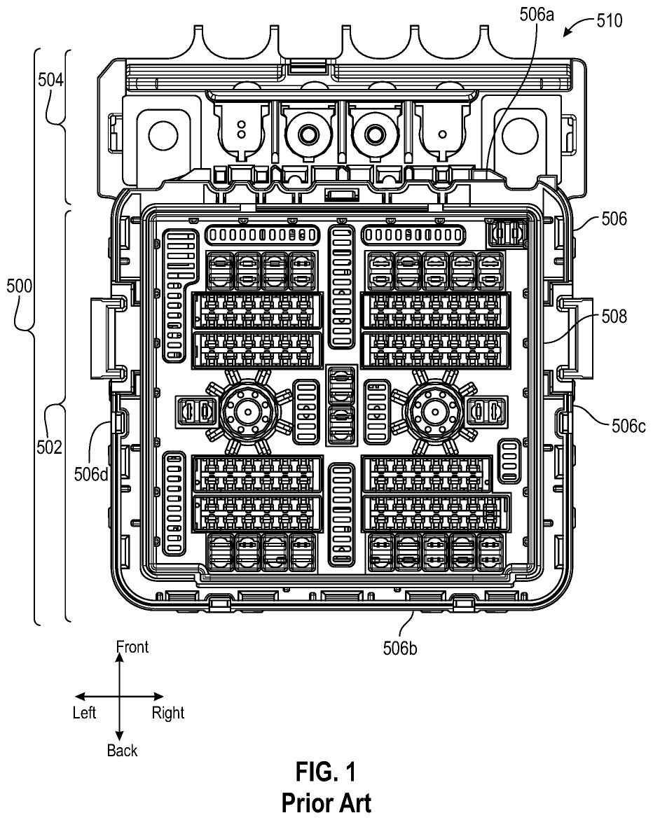

FIG. 2 is a top down view of a junction box assembly according to the principles of the present disclosure.

FIG. 3 is a top down view of FIG. 2 showing the top cover removed.

FIG. 4 is an exploded view of FIG. 2.

FIG. 5 is an isolated top down view of the upper case shown in FIG. 3.

FIG. 6 is an isolated perspective view of FIG. 5.

FIG. 7 is a cross-sectional view of FIG. 2 taken along line 7-7.

### DETAILED DESCRIPTION

An upper case includes an outer wall and an inner wall. The inner wall is disposed within and spaced apart from an inner surface of the outer wall so as to define a first space and a second space. The upper case further includes at least one rib. The rib is disposed between the outer wall and the inner wall so as to reinforce the outer wall.

The upper case may further include a bottom wall and the rib is spaced apart from the bottom wall to define a slot. The bottom wall may include an opening that is contiguous with the slot. The slot and the opening are configured to allow water to drain.

Directional terms as used herein—for example “up”, “down”, “right”, “left”, “front”, “back”, “top”, “bottom”—are made only with reference to the figures as drawn and are not intended to imply absolute orientation. As such, terms such as “upper”, “lower”, “height” and “width” are taken in context of the directional terms and the drawings.

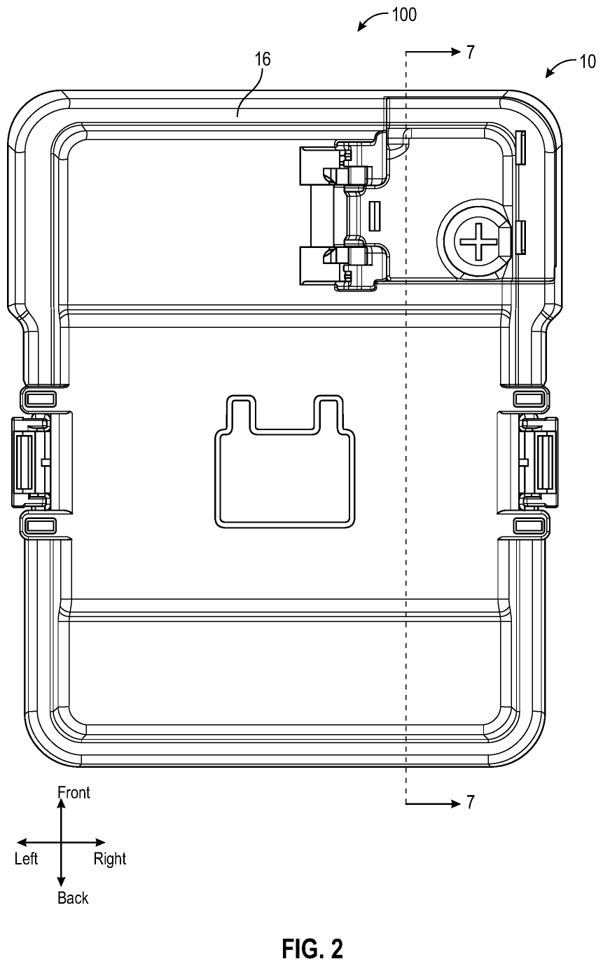

With reference now to FIGS. 2-6 an illustrative depiction of a junction box assembly 100 according to one or more embodiments disclosed herein is provided. The junction box assembly 100 includes a junction box 10 having an upper case 12 and a lower case 14. The junction box assembly 100 may further include a top cover 16 configured to cover the upper case 12. The upper case 12, lower case 14 and the top cover 16 may be formed of a material suitable for injection molding, illustratively including polypropylene, Acrylonitrile butadiene styrene, polyoxymethylene, polycarbonate and the like.

### The Upper Case

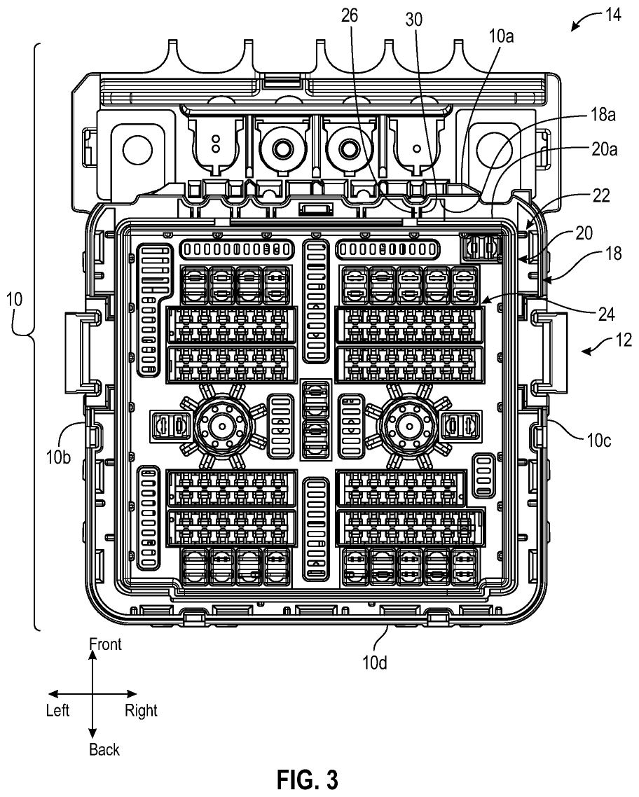

FIG. 3 is a top down view of the junction box assembly 100 with the top cover 16 removed, showing the upper case 12 and the lower case 14. The upper case 12 is shown as being generally rectangular; however, it should be appreciated that the dimensions of the upper case 12 may deviate from what is shown without limiting the scope of the appended claims. The upper case 12 includes a front portion 10a, a pair of side portions 10b, 10c and a back portion 10d. The upper case 12 includes an upper outer wall 18 defining the peripheral boundary of the upper case 12 and an upper inner wall 20 disposed within the upper outer wall 18. Thus, the upper outer wall 18 and the upper inner wall 20 form a respective front portion 10a, side portions 10b, 10c and back portion 10d of the upper case 12.

An exterior surface 20a of the upper inner wall 20 is spaced apart from the inner surface 18a of the upper outer wall 18 so as to define a first space 22. The upper inner wall 20 bounds a second space 24. The first space 22 is defined by the gap between the inner surface 18a of the upper outer wall 18 and the exterior surface 20a of the upper inner wall 20. The first space 22 is generally continuous so as to form a loop. As shown in FIG. 3, the first space 22 has a rectangular dimension and the second space 24 is generally rectangular in shape.

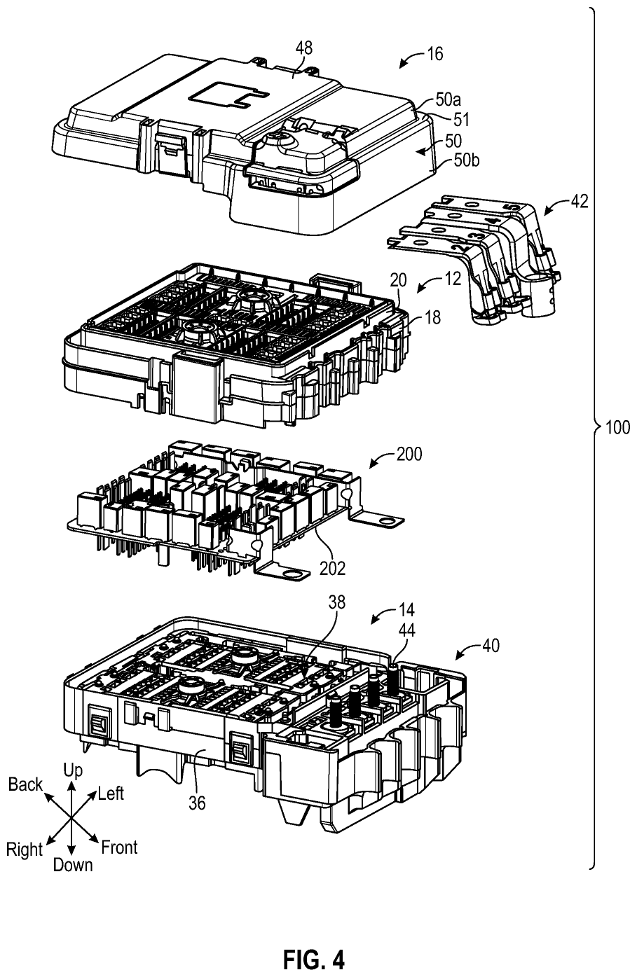

FIG. 4 is an exploded view of the junction box assembly 100. The upper case 12 may include features for accommodating various electric components 200 such as fuses, switches and the like. The electric components 200 may be mounted onto a circuit board 202. The circuit board 202 is seated onto the lower case 14 and the upper case 12 is mounted onto the circuit board 202 and the electronic components 200 so as to place the electric components 200 within the second space 24 of the upper case 12. In one aspect of the upper inner wall 20, the upper inner wall 20 is formed from two walls which are spaced apart from each other at a generally uniform distance. However, it should be appreciated that the upper inner wall 20 may be formed as a singular wall.

In this example, the dimension of the upper case 12 is designed to fit within a packaging space of an automotive vehicle, and accommodate a selected number of electric components 200. The upper case 12 may include conventional attachment features such as resilient tabs and hooks configured to secure the upper case 12 to other parts of the junction box assembly 100. In one aspect, the top cover 16 is further configured to protect and cover electrical components 200 housed within the junction box assembly 100, as will be described in further detail.

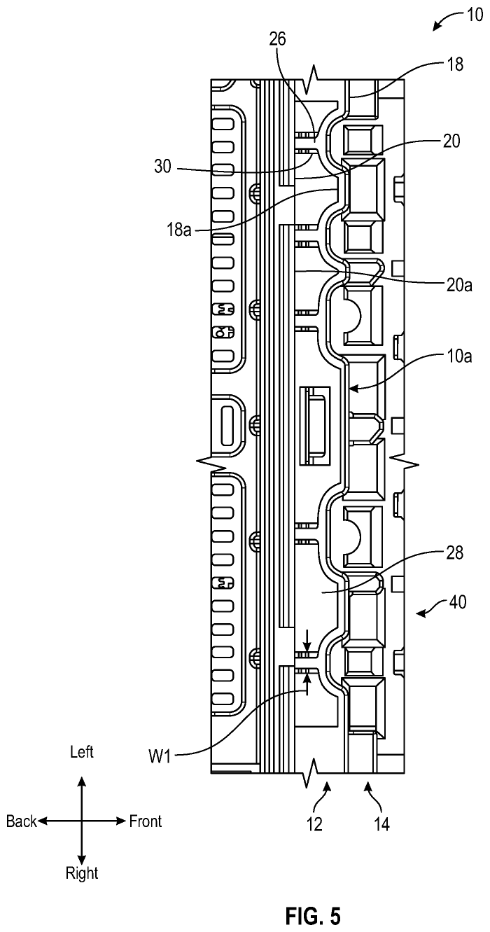

FIG. 5 is a top down view showing the front portion 10a of the upper case 12 and the corresponding portion of the lower case 14. The upper case 12 includes at least one rib 26 disposed between the upper outer wall 18 and the upper inner wall 20. The rib 26 may be a generally elongated member having a constant width “W1”. The rib 26 is configured to provide structural support to the upper outer wall 18 so as to prevent the upper outer wall 18 from deforming due to a cantilevered load. In one aspect, the ribs 26 are formed along the front portion 10a of the upper case 12.

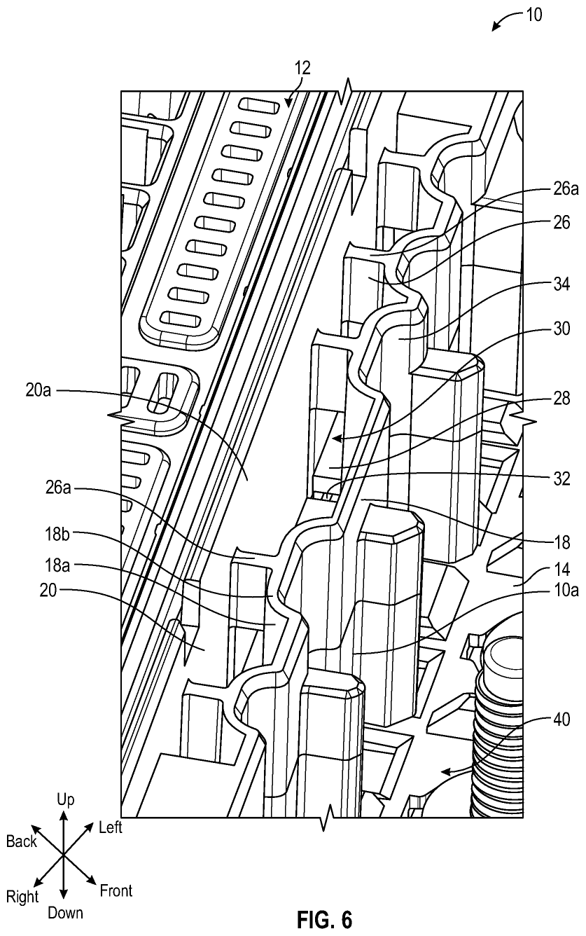

FIG. 6 is a perspective view of FIG. 5 taken from the top and right side of the junction box 10. The upper case 12 may include a bottom wall 28 and the rib 26 is spaced apart from the bottom wall 28 to define a slot 30. The slot 30 defines a passage through the bottom of the rib 26 as view along a width of the rib 26, in the direction indicated by the left and right arrows. The bottom wall 28 is a generally elongated member extending along a plane that is generally orthogonal to the upper outer wall 18. For illustrative purposes, the slot 30 is generally cuboidal and is disposed beneath the rib 26. A top surface 26a of the rib 26 may be coplanar with a top surface 18b of the upper outer wall 18.

The bottom wall 28 may include an opening 32. The opening 32 may be cuboidal in shape and may be contiguous with the slot 30. As shown in FIGS. 4 and 5, the bottom wall 28 may extend between the upper inner wall 20 and the upper outer wall 18 and is generally continuous between the side portions 10b, 10c of the upper case 12, only being interrupted by the openings 32. The opening 32 extends through the bottom wall 28 so as to allow for water to drain away from electrical components 200 and into the environment.

For illustrative purposes, the upper case 12 is shown as having five (5) ribs 26. Each rib 26 is disposed above a corresponding slot 30 and opening 32. The openings 32, the slots 30 and the ribs 26 are generally coplanar with each other. Further, each of the ribs 26 may be shaped similar to each other. Likewise, each of the openings 32 and slots 30 may be shaped similar to each other. However, it should be appreciated that the number of ribs 26 is provided for illustrative purposes and is not intended to limit the scope of the appended claims. Further, though the ribs 26, openings 32 and slots 30 are shown as being shaped similar to each other, the ribs 26, openings 32 and slots 30 may be shaped differently.

The upper outer wall 18 may include at least one recess portion 34. The recess portion 34 is an arcuate depression relative to the outer surface of the upper outer wall 18. In one aspect, the recess portion 34 extends along a height of the upper outer wall 18 (e.g., extending from the bottom wall 28 to the top surface 18b of the upper outer wall 18). The ribs 26 interconnects the upper outer wall 18 to the recess portions 34. For illustrative purposes, the recess portions 34 are shown as having different arcuate dimensions, each recess portion 34 is spaced apart from the other. Further, each recess portion 34 may be uniform along its respective height. The recess portions 34 are shown as being spaced apart from each other at different distances as measure by the width of the upper case 12. However, it should be appreciated that the dimensions of the recess portions 34 are not intended to be limiting to the scope of the appended claims and may be dimensioned other than what is shown without deviating from the scope of the appended claims.

In one aspect, the upper outer wall 18 may include five (5) recess portions 34, five (5) openings 32 and five (5) slots 30. Each rib 26 generally bisects a width of a corresponding recess portion 34. Likewise, each opening 32 and slot 30 generally bisects a width of a corresponding recess portion 34 as well. It should be appreciated that the rib 26 may be connected to a portion of the corresponding recess portion 34 that is offset from a center of the recess portion 34 as viewed along a width of the recess portion 34.

### The Lower Case

With reference again to FIGS. 2-6, an illustrative depiction of the lower case 14 is provided. The lower case 14 is configured to be at least partially disposed underneath the upper case 12. The lower case 14 includes a lower outer wall 36 which bounds the periphery of the lower case 14. The lower outer wall 36 is taller than a base 38, such that lower outer wall 36 encloses the base 38. The base 38 includes slots for receiving terminal pins of the electric components 200. The circuit board 202 is configured to be seated onto the base 38, and the upper case 12 is mounted on top of the lower case 14 to hold the electronic components 200 therein.

The lower case 14 further includes a terminal support portion 40. The terminal support portion 40 is illustratively shown as being a cuboidal member disposed on the front portion 10a of the lower case 14 and projects beyond the front portion 10a of the upper outer wall 18 of the upper case 12. The terminal support portion 40 is a platform for supporting one end of terminals 42, which are electrically coupled to at least one electric device on the other end. The terminals 42 may be electrically conductive members which are connected to predetermined electrical components disposed within both the second space 24 of the upper case 12 and the lower case 14. For illustrative purposes, the terminals 42 are shown as eyelet terminals 42 which are defined by an eyelet configured to engage a corresponding threaded stud 44 so as to secure the terminals 42 to a predetermined position within the terminal support portion 40, as shown in FIG. 3.

With reference now to FIGS. 3 and 6, the terminal support portion 40 is shown as being integrally formed to the lower case 14 and projects from the upper outer wall 18 of the upper case 12. The front portion 10a of the upper outer wall 18 of the upper case 12 rests along a portion of the terminal support portion 40. The terminals 42 are secured to the terminal support portion 40 by engagement of a threaded stud 44, wherein a threaded nut (not shown) may be threaded onto the threaded stud 44 and tightened onto the terminal 42. As such, the weight of the wires (not shown) secured to the free end of the terminals 42 may generate a cantilevered force on the upper outer wall 18 of the upper case 12.

The bottom wall 28 of the upper case 12 is disposed over a portion of the terminal support portion 40. As such, the slots 30 and the openings 32 are likewise disposed over the same portion of the terminal support portion 40, as shown in FIG. 6. The terminal support portion 40 further includes drain holes 46 for allowing water to drain into the environment.

### The Top Cover

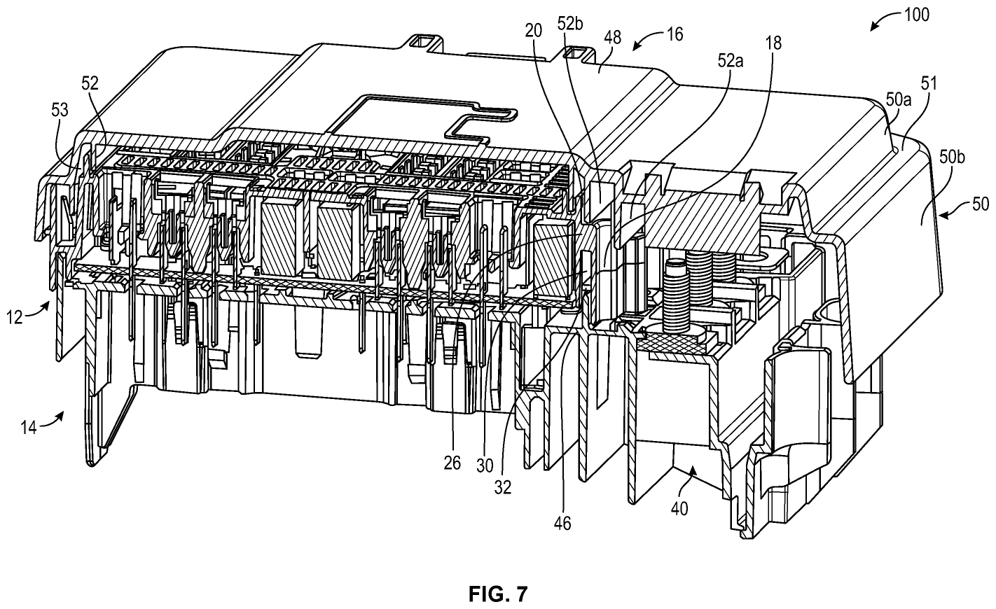

With reference now to FIGS. 4 and 7, the top cover 16 includes a top wall 48 and a lip 50 which bounds the periphery of the top wall 48. The top wall 48 is a generally planar member having a surface area which is greater than the surface area of the upper case 12 so as to cover the first space 22 and the second space 24 of the upper case 12. The lip 50 projects downwardly from the periphery of the top cover 16 and may include a shoulder portion 51 so as to define an upper lip portion 50a and a lower lip portion 50b, wherein the lower lip portion 50b is laterally offset from the upper lip portion 50a.

The interior surface 53 of the top cover 16 may include a plurality of interior panels 52 which project downwardly from the interior surface of the top cover 16. In one aspect, the top cover 16 includes a first interior panel 52a and a second interior panel 52b. The first interior panel 52a and the second interior panel 52b extend continuously along the interior surface of the top cover 16 to form a loop, wherein the second interior panel 52b is disposed within the first interior panel 52a. The first interior panel 52a is disposed within the first space 22 and the second interior panel 52b is disposed between the two walls forming the upper inner wall 20, as shown in FIG. 7.

With reference now to FIGS. 6 and 7, an operation of the junction box assembly 100 is provided. The upper case 12 is attached to the lower case 14 by a stud (not shown) extending through the upper case 12 and the lower case 14. When the terminals 42 are assembled to the terminal support portion 40 of the lower case 14, a downward load is placed on the free end of the terminal support portion 40 which places a reactionary cantilevered load onto the front portion 10a of the upper outer wall 18 of the upper case 12. Without the ribs 26, the reactionary cantilevered load may warp the upper outer wall 18, which may cause gaps between the upper outer wall 18 and the top cover 16, thereby allowing water to enter the gap. Water entering the gap may reach the first and second spaces 22, 24 of the junction box assembly 100 and cause damage to the electronic components 200 that are housed therein. However, the ribs 26 preserve the structural integrity of the upper outer wall 18 and prevent water from entering the first and the second spaces 22, 24 of the junction box assembly 100. In other words, the ribs 26 help prevent the upper outer wall 18 from warping due to a cantilevered load generated by the terminal support portion 40.

In addition, any water which gets through the upper outer wall 18 is drained to the exterior through the slots 30 and opening 32 of the bottom wall 28 of the upper case 12. In particular, the water is prevented from entering the interior space (e.g., the first and the second spaces 22, 24) of both the lower case 14 and the upper case 12 and is drained to the environment through the drain holes 46 of the terminal support portion 40 of the lower case 14. Accordingly, an upper case 12 and a junction box 10 is provided which includes at least one rib 26 configured to provide structural support to the upper outer wall 18 so as to help prevent the upper outer wall 18 from deforming due to a cantilevered load. In yet another benefit, the upper case 12 includes a slot 30 and an opening 32 to allow for water to drain through the drain holes 46 of the terminal support portion 40 of the lower case 14.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An upper case comprising;
an outer wall including an inner surface;
an inner wall disposed within and spaced apart from the inner surface of the outer wall so as to define a first space and a second space; and
at least one rib, the at least one rib disposed between the outer wall and the inner wall.

2. The upper case as set forth in claim 1, wherein the outer wall and the inner wall bound a rectangle dimension.

3. The upper case as set forth in claim 2, wherein the upper case includes a bottom wall and the at least one rib is spaced apart from the bottom wall to define a slot.

4. The upper case as set forth in claim 3, wherein the bottom wall includes an opening, the opening contiguous with the slot.

5. The upper case as set forth in claim 3, wherein the bottom wall extends between the inner wall and the outer wall.

6. The upper case as set forth in claim 3, wherein the at least one rib is at least five ribs.

7. The upper case as set forth in claim 6, including five openings and five slots.

8. The upper case as set forth in claim 7, wherein the outer wall includes at least one recess portion, the at least one rib interconnecting the inner wall to the at least one recess portion.

9. The upper case as set forth in claim 8, wherein the at least one recess portion is five recess portions.

10. The upper case as set forth in claim 8, wherein the opening, the slot and the at least one rib are disposed along a common plane.

11. A junction box assembly for housing electric components, the junction box assembly comprising:
a lower case having a terminal support portion; and
an upper case mounted onto the lower case, the upper case including an outer wall and an inner wall disposed within the outer wall, the terminal support portion extending beyond an outer surface of the outer wall of the upper case, the upper case further including at least one rib, the at least one rib disposed between the outer wall and the inner wall.

12. The junction box assembly as set forth in claim 11, wherein the outer wall and the inner wall bound a rectangle dimension.

13. The junction box assembly as set forth in claim 12, wherein the lower case includes a bottom wall, the bottom wall spaced apart from and above the terminal support portion of the lower case, and the at least one rib is spaced apart from the bottom wall to define a slot.

14. The junction box assembly as set forth in claim 13, wherein the bottom wall includes an opening, the opening contiguous with the slot, the opening configured to allow water to drain onto the terminal support portion of the lower case.

15. The junction box assembly as set forth in claim 13, wherein the bottom wall extends between the inner wall and the outer wall.

16. The junction box assembly as set forth in claim 13, wherein the at least one rib is at least five ribs.

17. The junction box assembly as set forth in claim 16, including five openings and five slots.

18. The junction box assembly as set forth in claim 17, wherein the outer wall includes at least one recess portion, the at least one rib interconnecting the inner wall to the at least one recess portion.

19. The junction box assembly as set forth in claim 18, wherein the at least one recess portion is five recess portions.

20. The junction box assembly as set forth in claim 18, wherein the opening, the slot and the at least one rib are disposed within a common plane.
